(19) United States
(12) Patent Application Publication
(10) Pub. No.: US 2026/0287003 A1
(43) Pub. Date: Sep. 24, 2026

(54) BOLT WITH WEAR PROTECTION

(71) Applicant: Caterpillar Inc., Peoria, IL (US)

(72) Inventors: Thomas Marshall Congdon, Dunlap, IL (US); Justin William Haller, Washington, IL (US)

(73) Assignee: Caterpillar Inc., Peoria, IL (US)

(21) Appl. No.: 19/087,120

(22) Filed: Mar. 21, 2025

(51) Int. Cl. F16B 35/06; B23K 1/00; B23K 1/19; B23K 103/00; B23K 103/04; B23K 103/16

(52) U.S. Cl. CPC F16B 35/065; B23K 1/0008; B23K 1/19; B23K 2103/04; B23K 2103/16; B23K 2103/52

(57) ABSTRACT

A fastener or bolt is fabricated by forming a cavity in a head of the bolt and attaching a hard insert at least partially over the head and within the cavity. The bolt may be used to attach a cutting edge to a tool such that the head of the bolt may be subject to an abrasive environment. The hard insert is harder than the head of the bolt and provides protection to the head of the bolt to reduce the rate of wear of the bolt. The hard insert may be fabricated by sintering and may include tungsten carbide and/or cobalt. The hard insert may be press fit and/or brazed onto the head of the bolt. The hard insert may include spacers on a side that engages the cavity of the head to allow room for the brazing material.

### TECHNICAL FIELD

The present disclosure relates to fasteners, such as bolts. More specifically, the present disclosure relates to bolts with wear resistant heads.

### BACKGROUND

Machines with cutting edges are in widespread use in construction, mining, forestry, and other similar industries. The cutting edges of the machines are used to dig, move, loosen, compact, and/or even any variety of materials, such as rocks, dirt, mineral ores, oil sands, gravel, asphalt, concrete, snow, ice, or the like. For example, a cutting edge may be mounted on a tool of a wheel loader to redistribute asphalt at a construction site or on a push shovel of a snow plow. The cutting edges are often used in harsh environments with excessive levels of wear and tear.

During operation, the cutting edges can wear as they abrade on surfaces of materials with which the cutting edge is in contact. The cutting edge may be mounted on a tool of a machine using any suitable type of fastener, such as a bolt. While the bolt holds the cutting edge in place on the tool, the bolt also wears as the tool is used. In other words, as there is wear and tear on the cutting edge itself, there is also wear and tear on the bolt holding the cutting edge in place. The wear on the bolt may result in reducing the operational lifetime of the bolt. The bolt may also be worn in a manner where it is difficult to remove the bolt. In some cases, the bolt may be worn such that sharp edges form on the bolt. Furthermore, conventional bolts made from steel may not provide much resistance to wear. Further yet, the bolt may wear to the point where the cutting edge is no longer reliably held onto the tool of the machine. If the cutting edge falls off of the tool during operation, the tool may be damaged.

An example of a bolt is described in Chinese Patent Publication No. 112343913 (hereinafter referred to as the '913 reference), where a bolt includes an anti-abrasion part. The '913 reference discloses that the anti-abrasion part is welded onto the bolt. However, this welding process for hard materials, like tungsten carbide (WC), can be difficult to accomplish and may be cost-prohibitive. Additionally, the thermal process of welding onto the bolt can change the crystal morphology of the bolt and reduce the hardness and/or toughness of the bolt.

Examples of the present disclosure are directed toward overcoming the deficiencies described above.

### SUMMARY

In an example of the present disclosure, a bolt includes a shank having an end and threading extending at least partially along an outer surface of the shank. The bolt further includes a head coupled to the shank opposing the end, the head having a surface and an insert disposed at least partially over the surface of the head, the insert having a first side and a second side opposing the first side. The first side includes spacers that contact the surface of the head and provide an offset between the surface of the head and the insert, the insert includes tungsten carbide (WC) and cobalt (Co), and the insert is harder than the head.

In another example of the present disclosure, a method of fabricating a bolt, incudes forming a rough bolt using steel, the rough bolt including a shank and a head and forming a cavity within the head, the cavity defined by a sidewall. The method further includes forming an insert, the insert comprising tungsten carbide (WC) and cobalt (Co), wherein a Co concentration is in a range of about 4% and about 25% and the insert includes a base portion and a top portion and attaching the insert to the rough bolt such that the base portion is disposed within the cavity and the top portion overlies the sidewall.

In yet another example of the present disclosure, a machine a tool, a cutting edge, and a bolt used to attach the cutting edge to the tool. The bolt includes a shank having an end, threading extending at least partially along an outer surface of the shank, a head coupled to the shank opposing the end, the head having a surface, and an insert disposed at least partially over the surface of the head, wherein the insert has a hardness greater than the hardness of the head.

### BRIEF DESCRIPTION OF DRAWINGS

FIG. 1 is a schematic illustration of an example machine with one or more cutting edges held by one or more bolts, according to examples of the disclosure.

FIG. 2 is a schematic sectional illustration of a cutting edge mounted to a tool of the example machine as depicted in FIG. 1, according to examples of the disclosure.

FIG. 3 is a schematic illustration of a bolt to hold a cutting edge mounted to a tool of the example machine as depicted in FIG. 1, according to examples of the disclosure.

FIG. 4 is an schematic exploded illustration of a bolt to hold a cutting edge mounted to a tool of the example machine as depicted in FIG. 1, according to examples of the disclosure.

FIG. 5 is a schematic sectional illustration of bolts holding a cutting edge, according to examples of the disclosure.

FIG. 6 is a schematic sectional illustration of a head of a bolt, according to examples of the disclosure.

FIG. 7 is a schematic bottom illustration of hard insert of a bolt, according to examples of the disclosure.

FIG. 8 is another schematic illustration of a bolt to hold a cutting edge mounted to a tool of the example machine as depicted in FIG. 1, according to examples of the disclosure.

FIG. 9 is a flow diagram of a method to fabricate a bolt, according to examples of the disclosure.

FIG. 10 is a flow diagram of a method to fabricate a bolt, according to examples of the disclosure.

FIG. 11 is a flow diagram of a method to fabricate a bolt with in-situ quench, according to examples of the disclosure.

### DETAILED DESCRIPTION

Wherever possible, the same reference numbers will be used throughout the drawings to refer to the same or like parts.

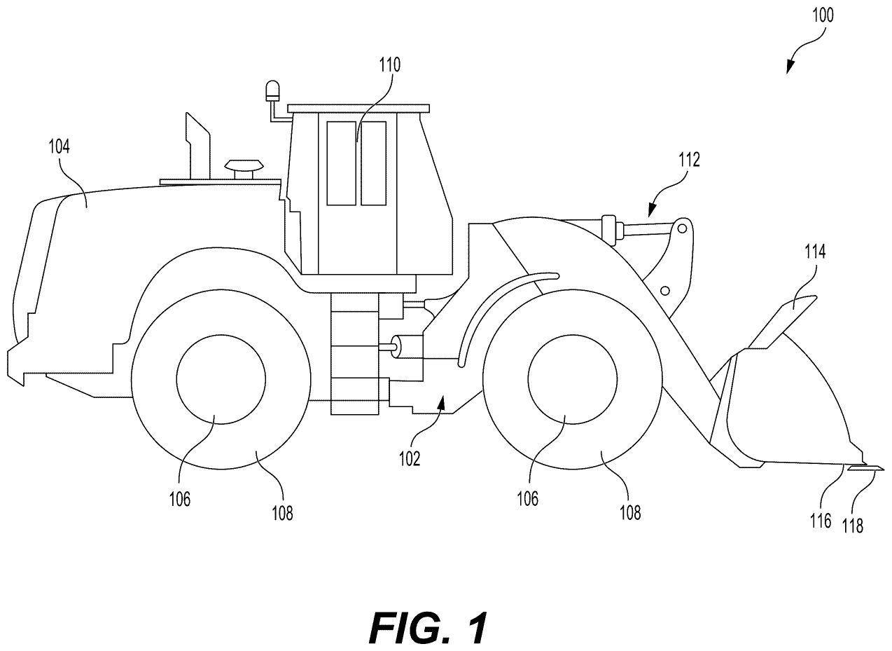

FIG. 1 is a schematic illustration of an example machine 100 with one or more cutting edges held by one or more bolts, according to examples of the disclosure. The machine 100, as depicted as a loader or wheel loader-type machine, includes a frame 102, an engine 104, wheels 106, and tires 108. However, in alternate examples the machine 100 may include any suitable propulsion system, such as a track chain. The machine 100 is depicted as a loader, but it should be understood that the machine 100 may be any suitable machine that performs work in any suitable application, such as mining, construction, oil extraction, construction, road repair, etc. In other examples, the machine 100 may be any one of a motor grader, dozer, loader, excavator, paver, compactor, combine, tank, backhoe, drilling machine, trencher, truck, or any other on-highway or off-highway vehicle.

The frame 102 may be of any suitable construction or type, such as steel construction. The engine 104 may be of any suitable type, such as internal combustion engine, fuel cell, and/or electric motor. The engine 104 may operate using any suitable fuel, such as diesel, gasoline, liquified natural gas (LNG), liquified petroleum gas (LPG), hydrogen, electricity, or the like.

In some examples, the machine 100 may include an undercarriage with a track chain, instead of wheels 106 and tires 108. The track chain may be driven by a number of sprockets and/or gears. The track chain may include a plurality of track shoes that link with each other to form the track chain. The fasteners, bolts, or similar apparatus, as disclosed herein, may be used in track chain assemblies to reduce wear and tear on the fastener. The machine 100 may further include an operator station 110 where an operator of the machine 100 may engage various controls of the machine 100 to control the machine 100 and its operations.

With continuing reference to FIG. 1, the machine 100 may also include one or more hydraulic systems 112 to control one or more tools 114. For example, the tool 114 is depicted as a bucket plow. The tool 114 may be of any suitable type, such as a motor grader, a tiller, a plow, a shovel, a hoe, a furrower, a rake, a trencher, or the like. The tools 114 may enable the machine 100 to perform tasks, such as digging, redistributing, tilling, scraping, etc. at a worksite, such as a construction site, mining site, oil extraction site, farm, etc. The tools 114 may be moved and/or operated by any suitable mechanism, such as hydraulic systems 112, as operated by an operator in the operator station 110 or remotely.

Some of the tools 114, such as a bucket plow or shovel plow may have a cutting edge mount 116 on which a cutting edge 118 may be attached, according to the disclosure herein. The cutting edge 118, as disposed on the tool 114, may be used for moving, breaking, and/or redistributing dirt, asphalt gravel, and/or other materials. For example, a cutting edge 118 may be disposed on any suitable machine 100 with any suitable tool 114 to provide protection and longevity to tool 114. Machines 100 that include a cutting edge 118 may include, for example, motor graders, dozers, scrapers, or the like. The cutting edge 118 may be subject to harsh operating environments with high frictional and/or abrasive wear conditions. Additionally, fasteners used to attach the cutting edge 118 to the tool 114 are also subject to the harsh operating environments with high frictional and/or abrasive wear conditions. Thus, it is desirable to improve material properties, such as hardness and toughness, of the fasteners used to hold the cutting edge 118 to improve their usable life and/or to impart additional wear protection to the cutting edge 118 itself.

According to examples of the disclosure, fasteners used to hold the cutting edges 118, may be formed in a manner that improves their wear resistance, while maintaining and/or improving their overall toughness. The mechanisms, as disclosed herein, may apply to any variety of fasteners and bolts to increase the hardness and/or toughness of those components. For example, similar processes as disclosed herein may be used to form wear resistant screws, nails, rivets, cap nuts, carriage bolts, or the like. Although discussed herein in the context of bolts for holding a cutting edge 118, it should be understood that the systems and methods disclosed herein, can improve the wear resistance of fasteners used in other ground-engaging components of the machine 100, such as track chain components.

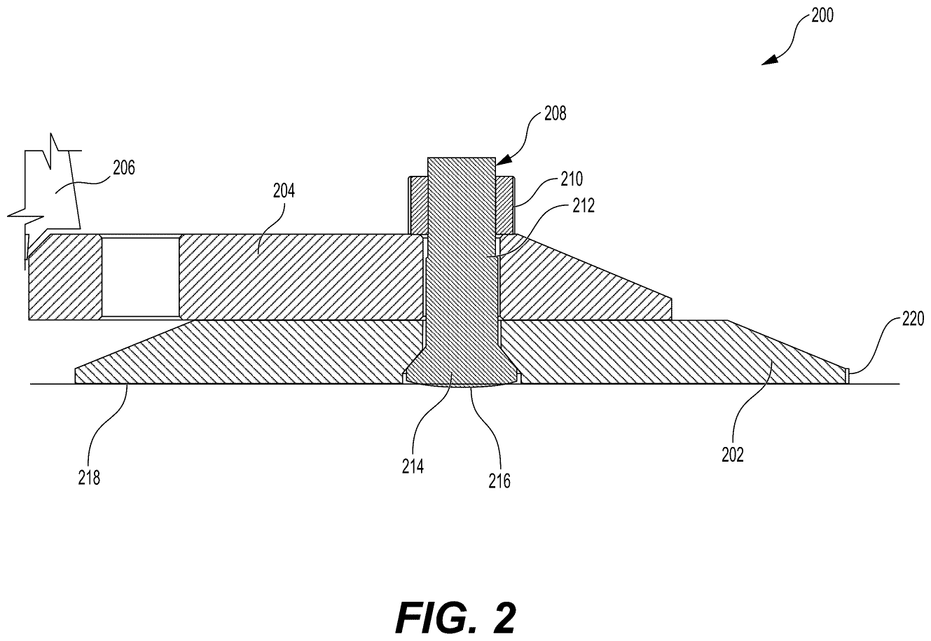

FIG. 2 is a schematic sectional illustration of an environment 200 with a cutting edge 202 mounted to a cutting edge mount 204 of a tool 206 of the example machine 100 as depicted in FIG. 1, according to examples of the disclosure. It should be understood that in some cases, the cutting edge 202 may be mounted directly on the tool 206 without a cutting edge mount 204. The cutting edge 202 and the cutting edge mount 204 may be examples of cutting edge 118 and cutting edge mount 116 of FIG. 1.

The cutting edge 202 may be attached to the cutting edge mount 204 and/or the tool 206 using any suitable fastener, such as bolt 208. The bolt 208 may be engaged by nut 210 to securely hold the cutting edge 202 in place. The bolt 208 may include a shank 212 rigidly connected to a head 214. The shank 212 and the head 214 may be of any suitable size to hold the cutting edge securely to the tool 206 and/or cutting edge mount 204.

The bolt 208, as described herein, may include a variety of improvements that increase their operating lifetime and/or ease of use. According to examples of the disclosure, the bolt 208 may include a hard insert 216 over a top of the head 214 of the bolt 208. The hard insert 216 may be prefabricated and then attached to the head 214 of the bolt 208. In some cases, a cavity may be formed within the head 214 of the bolt 208 to receive and attach the hard insert 216.

The cutting edge 202 may engage the ground 218 at a ground engaging edge 220 of the cutting edge 202. As the cutting edge 202 scrapes along the ground 218, it will be understood that there will be tribological wear and tear along a length and/or width of the cutting edge 202. However, at the same time, the head 214 of the bolt 208 also wears. The wear of the bolt may present several infirmities, such as difficulty for a maintenance worker to remove the bolt 208 when the cutting edge 202 is to be replaced, sharp worn edges on the bolt 208 that can damage property or hurt people, and/or the detachment of the cutting edge 202 from the tool 206 and/or the cutting edge mount 204. Additionally, conventional bolts 208 do not provide any resistance to wear for the cutting edge 202.

The bolts 208, as disclosed herein, include abrasion resistant material within the hard insert 216. For example, the hard insert 216 may be fabricated from tungsten carbide (WC), cobalt (Co), and/or any other suitable hard material. The shank 212 and the head 214 of the bolt 208 may be fabricated from any suitable material, such as steel. For example, the head 214 and the shank 212 of the bolt 208 may be made from boron-steel to give it a substantially martensitic grain structure, which provided good hardness and toughness. However, even with preferential crystal structure, the head 214 and shank 212 of the bolt 208 may be subject to high levels of wear and tear when in use. The hard insert 216 is harder than the steel construction of the head 214 and shank 212 of the bolt, providing increased resistance to wear.

The bolts 208, as described herein, provide a variety of advantages over conventional bolts. The bolts 208 provide enhanced protection of the tools 114 on which they are disposed. The bolts 208, with the features disclosed herein, may have a greater operational lifetime than conventional bolts without the hard insert 216. In some cases, the bolts 208 may have an operational lifetime greater than 350 hours. In other cases, the bolts 208 may have an operational lifetime greater than 1860 hours. In still other cases, the bolts may have an operational lifetime greater than 2000 hours. In yet other cases, the bolts 208 may have an operational lifetime greater than 2500 hours.

It will be appreciated that by providing hard materials in selective locations of the bolts 208, while the head 214 and the shank 212 are a relatively ductile structure, the bolt 208 has improved toughness relative to conventional bolts. Additionally, the bolt 208 is easier to use, since the wear resistant hard insert 216 does not wear away with use and can be used (e.g., tightened or loosened) by an operator even after use of the cutting edge 118.

The hard insert 216 may be attached to the head 214 of the bolt 208 by any suitable joining mechanism, such as brazing, welding, soldering, fritting, etc. For example, in some cases, a copper (Cu) and/or nickel (Ni) metallurgy may be used to braze the hard insert 216 in place within a cavity cut into the head 214 of the bolt 208. In other cases, other metals may be used for brazing the hard insert 216 in place, such as silver (Ag), zinc (Zn), tin (Sn), cobalt (Co), gold (Au), or the like.

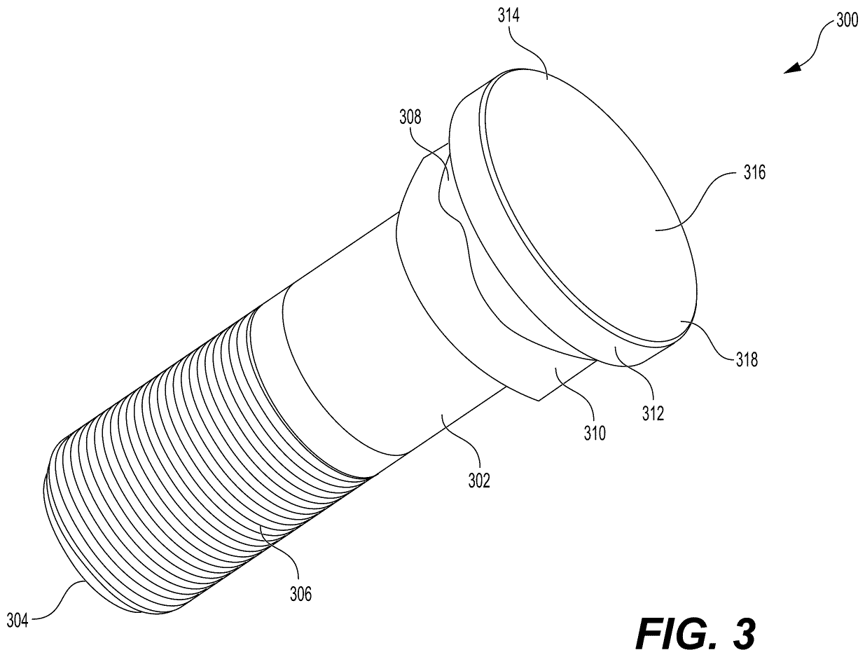

FIG. 3 is a schematic illustration of a bolt 300 to hold a cutting edge 118 mounted to a tool 114 of the example machine 100 as depicted in FIG. 1, according to examples of the disclosure. The bolt 300 may be an example of bolt 208. The bolt 300 includes a shank 302 that extends to an end 304, with threads 306 on a portion of the shank 302. The bolt includes a head 308 on an end of the shank 302 opposing the end 304. The bolt 300 may have an intermediary region 310 between the shank 302 and the head 308. In some cases, the intermediary region 310, may serve as a countersink with topology that mates with the hole on the cutting edge 118 through which the bolt 300 is disposed. The countersink of the intermediary region 310 may improve the strength and hold of the joint formed by the bolt 300 and nut 210.

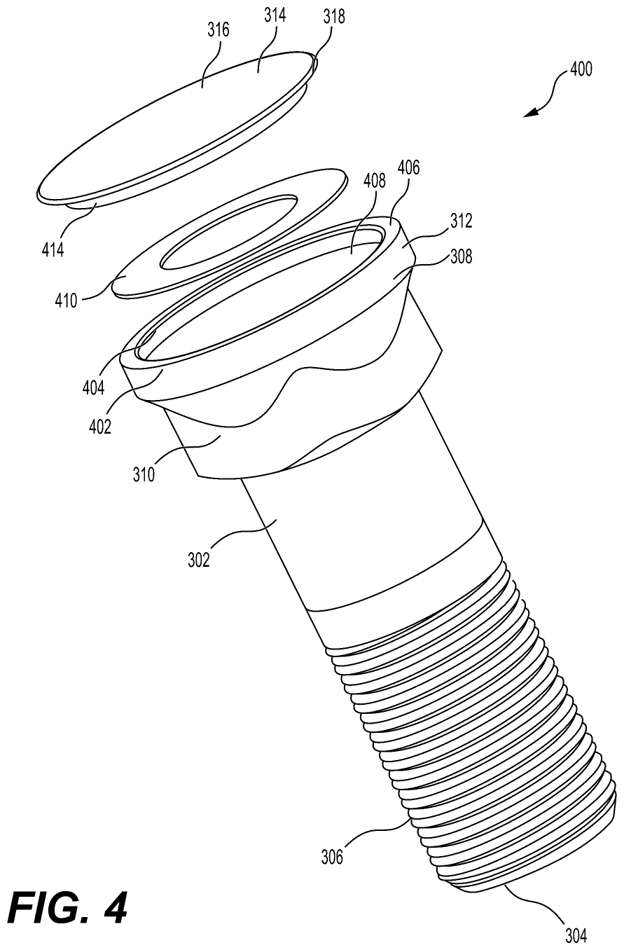

The head 308 of the bolt 300 may include a sidewall 312. The sidewall 312 may define a cavity, as will be discussed in conjunction with FIG. 4, that holds a hard insert 314. The hard insert 314 provides protection for the head 308 of the bolt 300, as the cutting edge 118 is used in tribologically harsh environments. The hard insert 314 may have a top surface 316 with a lip 318 that is disposed over the sidewall 312 of the head 308. The lip 318, therefore, protects the head 308 all the way to its edge, as defined by sidewall 312. In some cases, the top surface 316 may have a convex shape, protruding upward. This convex shape of the insert 314 may ensure that it is the first portion of the bolt 300 that is subject to tribological load when a cutting edge 118 held by the bolt 300 is in use.

The composition of the hard insert 314 may include any suitable materials, such as hard materials like tungsten carbide (WC), tungsten nitride, Co-based materials, borides, oxides, nitrides, or carbides of refractory metals (e.g., titanium (Ti), tantalum (Ta), tungsten (W), chromium (Cr), molybdenum (Mo), etc.), alumina (Al₂O₃), corundum, silicon carbide (SiC), or the like. The hard insert 314 may be fabricated using a sintering process, such as powder sintering, liquid sintering, or the like. In some cases, the sintering process may be enhanced with electric and/or magnetic fields. In general, powders of the constituent materials may be placed in a sintering mold and then heated and/or pressurized to fabricate the hard insert 314. For example, WC nanoparticles may be placed in a sintering mold under compression and heat to sinter-form the hard insert 314.

In some cases, WC nanoparticles may be mixed with Co nanoparticles with any suitable concentration, such as between 4% and 25% Co, by weight, in the powder sintering process. In some cases, the sintering process to form the hard insert 314 may use approximately 5% to 25% Co particles with the remainder WC particles to provide the hard insert 314 with Co in the range of about 5% to about 25%. In other cases, the sintering process to form the hard insert 314 may use approximately 6% to 13% Co particles with the remainder WC particles to provide the hard insert 314 with Co in the range of about 6% to about 13%. In yet other cases, the sintering process to form the hard insert 314 may use approximately 10% to 12% Co particles with the remainder WC particles to provide the hard insert 314 with Co in the range of about 10% to about 12%.

The hard insert 314 may have any suitable hardness, such as hardness in the range of about 80 Rockwell Hardness Scale A (HRA) to about 95 HRA. In other cases, the hard insert 314 may have a hardness in the range of about 83 HRA to about 92 HRA. In some cases, the hard insert 314 may have a hardness in the range of about 86 HRA to about 92 HRA. Hard insert 314 may have a greater hardness than the head 308, intermediary region 310, and/or the shank 302. In general, the head 308, intermediary region 310, and/or the shank 302 of the bolt 300 may be constructed from steel, while the hard insert 314 is constructed from materials harder than steel, such as carbides, nitrides, and/or oxide of refractory metals.

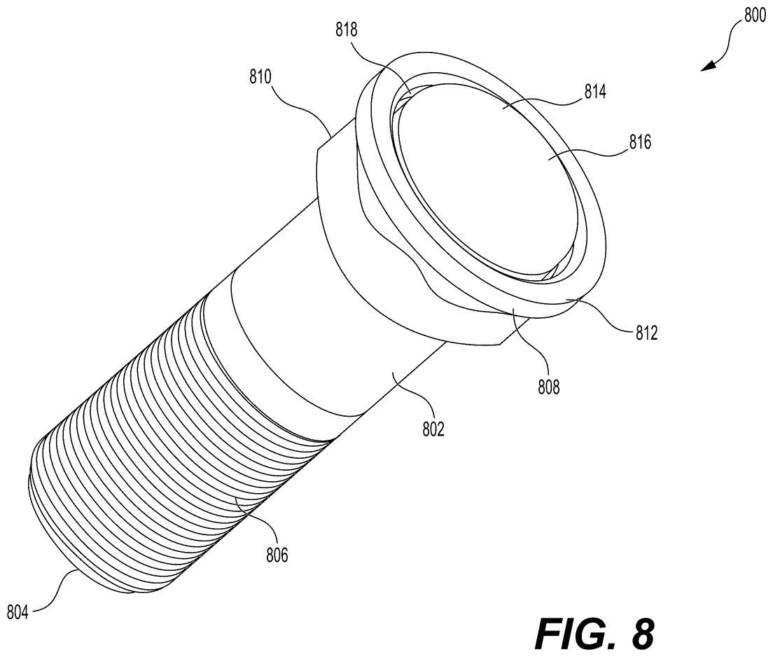

The extension of the hard insert 314 all the way to the edge of the head 308, covering the sidewall 312 may provide for extra tribological protection of the steel constructed portions of the bolt 300. In other cases, the hard insert may not extend over the full surface of the head 308 of the bolt, as will be discussed in conjunction with FIG. 8. In some cases, the steel constructed portions of the bolt 300 may include any suitable type of steel, such as boron steel, low carbon steel, medium carbon steel, and/or high carbon steel. In many cases, the composition of the steel in the head 308, shank 302, and the intermediary region 310 may be uniform. In other cases, the composition of the steel in the head 308, shank 302, and the intermediary region 310 may not be the same throughout. For example, in some cases, the threads 306 may have a lower carbon content to increase the ductility of the threads 306.

The bolt 300 may be of any suitable size. For example, the diameter of the shank 302 may be in a range of about 0.25 inch to about 2 inches. In some cases, the diameter of the shank 302 may be in a range of about 0.375 inch to about 1.75 inch. In some other cases, the diameter of the shank 302 may be in the range of about 0.5 inch to about 1.5 inch. The threads 306 may have any suitable thread pitch. Furthermore, the threads 306 may extend any suitable distance along the shank 302 proximal to the end 304.

The head 308 of bolt 300 may be of any suitable size. For example, the diameter of the shank 302 may be in a range of about 0.375 inch to about 4 inches. In some cases, the diameter of the shank 302 may be in a range of about 0.5 inch to about 2.5 inch. In some other cases, the diameter of the shank 302 may be in the range of about 1 inch to about 3 inch.

FIG. 4 is a schematic exploded illustration of a bolt 400 to hold a cutting edge 118 mounted to a tool 114 of the example machine 100 as depicted in FIG. 1, according to examples of the disclosure. Bolt 400 may be an example of bolt 300 and/or bolt 208. The head 308 of the bolt 400 includes the sidewall 312. The sidewall includes an outer surface 402, an inner surface 404 opposing the outer surface 402, and a top surface 406 extending circumferentially from the outer surface 402 to the inner surface 404 and substantially perpendicular to both the outer surface 402 and the inner surface 404.

The inner surface 404 defines a cavity 408 within the head 308 of the bolt 400. Brazing material 410 may be disposed within the cavity 408 to hold the insert 314 within the cavity 408 and covering the head 308 of the bolt 400. The insert or hard insert 314 may include a protrusion 414 that is disposed within the cavity 408 to join the insert 314 to the head 308 of the bolt 400. The protrusion 414 may be in contact with the inner surface 404 of the sidewall 312 and/or the brazing material 410 to be held within the cavity 408. When the protrusion 414 is inserted within the cavity 408, the lip 318 of the insert 314 substantially covers the top surface 406 of the bolt 400. In this way, most of the head 308 of the bolt 400 is covered by the insert 314, providing tribological protection to the head 308 of the bolt 400.

The steel portions of the bolt 400 may be formed by any suitable steel forming process, such as forging, casting, extruding, or the like. For example, in some cases, the rough bolt may be formed using cold forging. A rough bolt may be formed through steel forming processes and then the insert 314 may be joined thereon. In some cases, the cavity 408, as defined by inner surface 404, may be formed within the rough bolt during the steel forming process itself. In other cases, the cavity 408 may be formed using any suitable machine tool, such as a drill, lathe, grinder, punch, or the like.

The carbon content of the steel of the rough bolt may be in the range of about 0.05% to about 1.2% by weight. In some examples, the steel may be a low-carbon steel, with a carbon content of the base cutting edge in the range of about 0.1% to about 0.3% carbon by weight. In other examples, the steel may be a medium-carbon steel, with a carbon content of the base cutting edge in the range of about 0.3% to about 0.6% carbon by weight. In yet other examples, the steel may be a high-carbon steel, with a carbon content of the base cutting edge in the range of about 0.6% to about 1.2% carbon by weight. In still other examples, low or medium carbon boron steel may be used to form the rough bolt.

In some cases, the rough bolt may be subject to a thermal hardening process, where the rough bolt is heated and then quenched to form hard martensitic and/or austenitic grain structure. The rough bolt may have any suitable hardness, such as in the range of about 40 Rockwell Hardness Scale C (HRC) to about 65 HRC. In other cases, the rough bolt may have a hardness in the range of about 45 HRC to about 63 HRC. In yet other cases, the rough bolt may have a hardness in the range of about 49 HRC to about 60 HRC.

Although the brazing material 410 is depicted here as a solid ring, it should be understood that the brazing material 410 to hold the hard insert 314 onto the head 308 of the bolt 400 may be provided in any suitable form. For example, the brazing material may be provided in the form of metallic powder, strip, melt pool, or the like. In some cases, a Cu and/or Ni metallurgy may be used to braze the hard insert 314 in place within the cavity 408 of the head 308 of the bolt 400. In other cases, other metals may be used for brazing the hard insert 314 in place, such as Ag, Zn, Sn, Co, Au, or the like. Alternatively, the hard insert 314 may be attached to the head 308 of the bolt 208 by any other suitable joining mechanism, such as welding, soldering, fritting, etc.

The brazing process for joining the insert 314 to the head 308 may occur at relatively high temperatures. For example, the brazing process may be performed at temperatures in a range of about 550° C. to about 1200° C. In some cases, the brazing process may be performed at temperatures below the eutectic point of carbon steel, such that the thermal process of brazing does not alter the crystal grain structure of the rough bolt while attaching the insert 314 onto the rough bolt. By using relatively low-temperature processes downstream of the formation of the rough bolt, the properties (e.g., hardness, etc.) of the rough bolt are substantially unchanged. However, in other cases, the time and temperature of the brazing process may alter the grain structure of the rough bolt. For example, the heating and subsequent cooldown of the rough bolt may result in at least partial transformation of harder austenitic and/or martensitic grain structure to softer pearlite, ferrite, and/or cementite. In this case, as disclosed herein, a reheat and quench process may be performed after the brazing process to reharden the steel of the bolt 400. In other cases, an in-situ direct to quench process may be used after the brazing process, where the bolt 400 is quenched directly from the brazing temperature. The quenching process may be any suitable quenching process, such as in air, water, oil, combinations thereof, or the like.

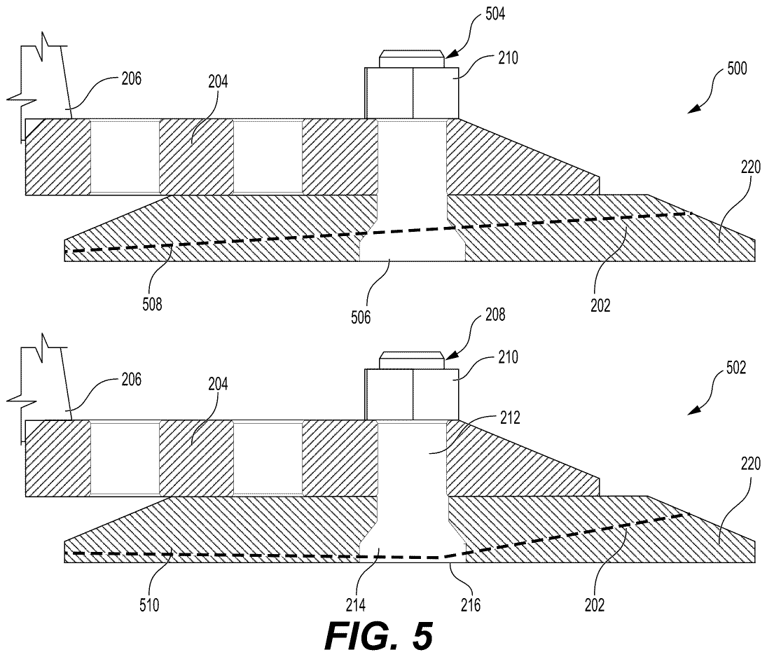

FIG. 5 is a schematic sectional illustration of assemblies 500, 502 with bolts holding a cutting edge, according to examples of the disclosure. A conventional bolt 504 without any insert on its head 506 may display the wear profile 508. In this wear profile 508, the higher up the dotted line, the greater the wear on the corresponding areas of the cutting edge 118. The wear profile 508 indicates a continuous decrease in the level of wear moving away from the leading edge 220 of the cutting edge 202. However, the conventional bolt 504 provides neither wear resistance for itself nor imparts wear resistance to the cutting edge 202.

In contrast to the conventional bolt 504, in the case of the bolt 208 with wear protection of the insert 314, as disclosed herein, the wear profile 510 is quite different from the wear profile 508 for the conventional bolt 504. Due to the increased hardness of the insert 314 relative to the conventional bolt 504 and the cutting edge 202 itself, the bolt 208 provides wear resistance to portions of the entire assembly 502. As demonstrated in wear profile 510, the rate of wear diminishes in a discontinuous way at the bolt 208. Thus, the bolt 208, as disclosed herein, not only diminishes the wear of the bolt 208 itself, but the bolt also reduces the level of wear imparted to portions of the cutting edge 202. In some cases, the reduced level of wear imparted by the bolt 208 with the insert 314 may extend the usable lifetime, during use, of one or both of the bolt 208 and/or the cutting edge 202.

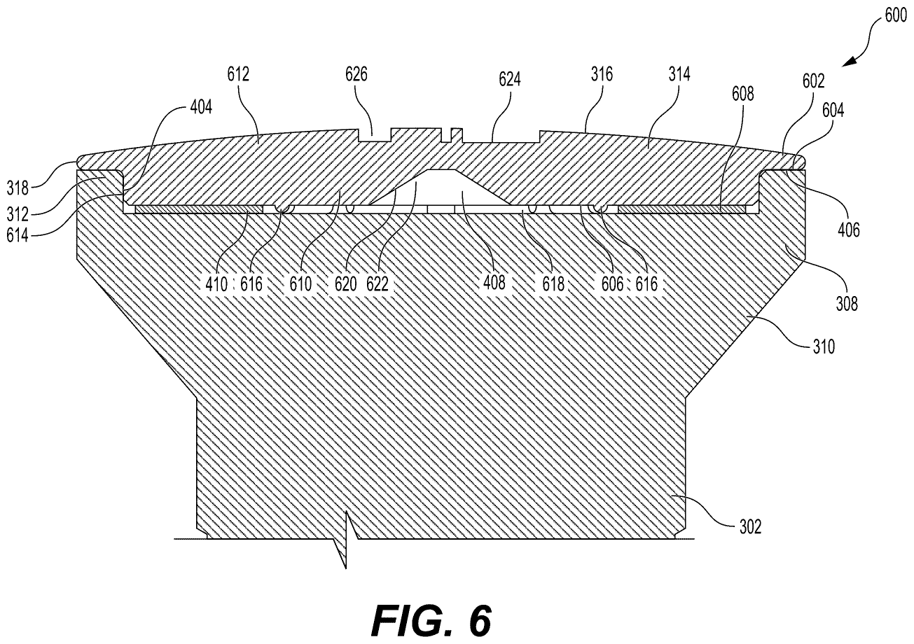

FIG. 6 is a schematic sectional illustration of a portion 600 of a bolt 208, according to examples of the disclosure. The hard insert 314 or insert, with the surface 316 and lip 318 includes a top surface 602 of the lip 318 and a bottom surface 604 of the lip 318. When installed on the machine 100, the top surface 602 of the lip 318 would come in contact with the material, such as gravel, asphalt, dirt, snow, etc., being moved. By overlying the head 308 of the bolt 208, including the top surface 406 of the sidewall 312, the lip 318 provides tribological protection all the way to the edge (e.g., sidewall 312) of the head 308. When the insert 314 is seated in the head 308, the bottom surface of the lip 318 may be in contact or very close proximity with the top surface 406 of the sidewall 312.

The insert 314 may further include a bottom surface opposing the top surface 316 of the insert 314. The bottom surface 606 of the insert 314 may be in contact with or proximal to a top surface 608 of the cavity 408 of the head 308. The bottom surface 606 may be the bottom of the insert 314 and also the bottom of a base portion 610 of the insert 314. The base portion 610 and a top portion 612, including the lip 318, are portions of the insert 314. Put another way, the hard insert 314 may be shaped like a muffin or a mushroom. In such a visualization, the top portion 612 is analogous to the muffin top or mushroom cap, while the base portion 610 is analogous to the muffin bottom or mushroom stem. When the base portion 610 is disposed within the cavity 408 of the head 308, a sidewall 614 of the base portion 610 may be in contact with the inner surface 404 of the sidewall 312 of the head 308. In some cases, there may be a relatively strong frictional hold between the sidewall 614 and the inner surface 404.

The bottom surface 606 of the insert 314 may include one or more spacers 616 or protrusions of the bottom surface 606. The spacers 616 allow for a space 618 between the bottom surface 606 and the top surface 608 of the cavity 408. The space 618 may allow room for the brazing material 410 between the insert 314 and the top surface 608 of the cavity 408. The bottom surface 606 may also optionally include one or more sidewalls 620 to form topographical features 622 therein. Although feature 622 resembles a nipple and may have a circular trapezoidal shape, it should be understood that the feature 622 may be of any suitable shape, size, and/or resemblance. The feature 622 may serve any variety of purposes, such as stress relief and/or to provide a reservoir for any excess brazing material 410 to flow during the brazing process for joining the hard insert 314 to the head 308 of the bolt 208. The feature 622 may further serve as a wear indicator. In other words, the feature 622 may provide a mechanism for an operator to identify when the insert 314 is worn such that the insert 314 and/or the bolt 208 is to be replaced. For example, if an operator sees a hole in the insert 314 corresponding to the feature 622, then the operator may ascertain that the insert 314 and/or bolt 208 may be in need of replacement.

The top surface 316 of the insert 314 may optionally have topography 624 therein, defining surface features 626. The surface features 626 may provide writing, images, and/or other indicia on the surface 316 of the hard insert 314. The features 626 may provide instructions, warnings, logos, or the like on the top surface 316 of the hard insert 314.

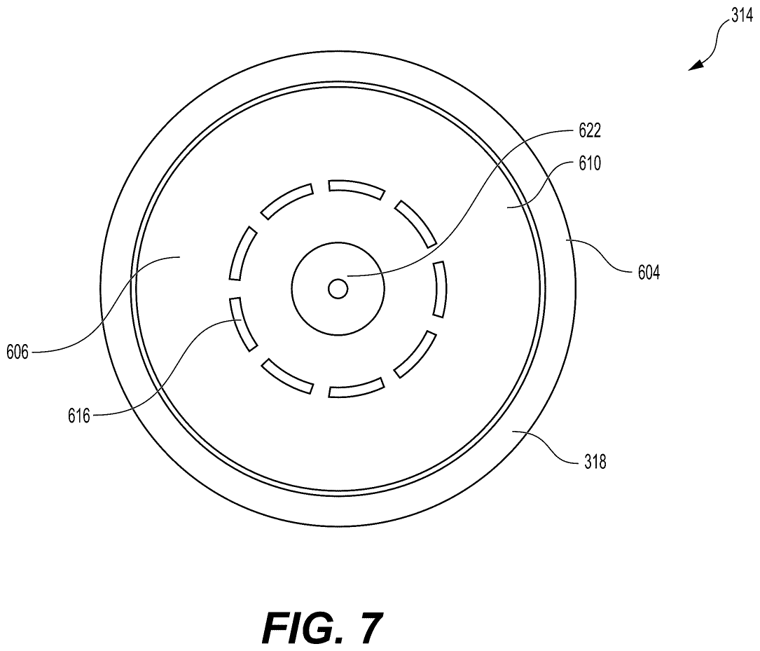

FIG. 7 is a schematic bottom illustration of the hard insert 314 of the bolt 208, according to examples of the disclosure. As shown, the lip 318 of the hard insert 314 is on the outer circumference of the insert 314 and includes the bottom surface 604 of the lip 318, which is adjacent to the upper surface 406 of the sidewall 312 of the head 308 of the bolt 208. The base portion 610 of the hard insert 314 includes the bottom surface 606 of the hard insert 314. The bottom surface 606 of the hard insert 314 further includes the spacers 616 to provide an offset or space 618 between the bottom surface 606 and the top surface 608 of the cavity 408. The space 618 may allow room for the brazing material 410 between the insert 314 and the top surface 608 of the cavity 408.

FIG. 8 is another schematic illustration of another bolt 800 to hold a cutting edge 202 mounted to a tool 114 of the example machine 100 as depicted in FIG. 1, according to examples of the disclosure. The bolt 800 may be an example of bolt 208. The bolt 800 includes a shank 802 that extends to an end 804, with threads 806 on a portion of the shank 802. The bolt 800 includes a head 808 on an end of the shank 802 opposing the end 804. The bolt 800 may have an intermediary region 810 between the shank 802 and the head 808. In some cases, the intermediary region 810, may serve as a countersink with topology that mates with the hole on the cutting edge 118 through which the bolt 800 is disposed. The countersink of the intermediary region 810 may improve the strength and hold of the joint formed by the bolt 800 and nut 210.

The head 808 may include a sidewall 812. However, in this example bolt 800, the sidewall 812, as constructed of steel, may not be covered by insert 814. Thus, the sidewall 812 may be partially exposed during the operation of the tool 114 on which the bolt 800 is provided. The hard insert 814 may include a top surface 816 and a sidewall 818. The sidewall 818 may at least partially be within the cavity 408 defined by the sidewall 812 of the head 808 of bolt 800. The top surface 816 may have a convex shape, bowing outwards. In some cases, the top surface 816 may protrude beyond the sidewall 812 so that the insert 814 is more likely to be subject to tribological loads, as compared to the sidewall 812. In this way, the insert 814 may protect the head 808 of the bolt 800, when a cutting edge 118 held by the bolt 800 is engaged in any activities that impart wear and tear.

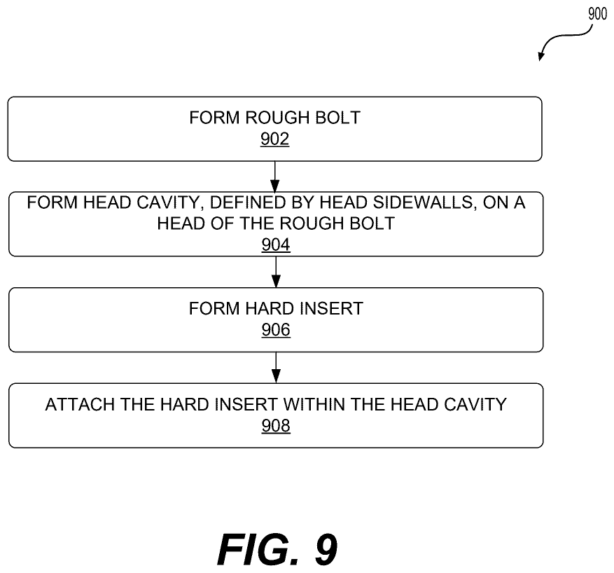

FIG. 9 is a flow diagram of a method 900 to fabricate the bolt 208, according to examples of the disclosure. The processes of method 900 may be performed by a single entity at a single location or any number of different entities at any variety of locations. For example, portions of the method 900 to fabricate the bolt 208 may be performed at a steel mill to form the steel portions of the bolt 208. Other processes, such as machining and/or assembling the bolts 300 may be performed in a machine shop and/or an assembly floor. The insert 314 may be fabricated and/or joined at yet another one or more facilities.

At block 902, a rough bolt may be formed. The bolt may be rough formed by a cold forging process, where wires or rods are rolled between rollers to shape the rough bolt. In other cases, other processes, such as hot forging, casting, extruding, or the like may be used to form the rough bolt prior to providing the insert 314 thereon. With a hot-rolling mechanism, where steel, such as in the form of wires, rods, and/or any other suitable starting form, may be heated and rolled between rollers (e.g., a top roller and a bottom roller) to achieve the shape of the bolt 300. While the cold forging process may be performed at or near room temperature, in the hot-rolling mechanism, the starting steel material may be heated to a relatively high temperature, such as an austenitizing temperature. This temperature may be above about 1000° C. At these temperatures, the steel may change its crystal structure based at least in part on its content and subsequent thermal profiles. For example, the steel may be heated to between about 1100° C. and about 1300° C. The steel may be quenched, in some cases, after a heated forming process (hot forging, casting, etc.). In alternative examples, the rough bolt may be formed from material(s) other than steel.

The steel used to form the bolt 300 may be of any suitable type and may include any suitable additives and/or impurities therein. For example, the steel used to form the rough bolt may include Iron (Fe) with a variety of additives and/or impurities therein, such as carbon (C), boron (B), manganese (Mn), phosphorus (P), sulfur(S), silicon (Si), molybdenum (Mo), chromium (Cr), vanadium (V), and/or other materials. In some cases, the concentration of additives and/or impurities may be relatively uniform throughout. In other cases, the concentration of the additives and/or impurities may be non-uniform throughout the steel. For example, the outer portions of the steel components, such as the base cutting edge, may be such that the outer portions of the components are harder than the inner portions of the components due to a higher concentration C near its surfaces. In some cases, the base cutting edge may be subject to a hardening process, such as heating to an elevated temperature and quenching to form martensitic and/or austenitic crystal structure. In the same or other cases, the base cutting edge may be subject to surface hardening processes, such as carburizing and/or hard facing, to form a hard outer surface and a softer and/or ductile bulk portion.

The carbon content of the steel and the base cutting edge may be in the range of about 0.05% to about 1.2% by weight. In some examples, the steel may be a low-carbon steel, with a carbon content of the base cutting edge in the range of about 0.1% to about 0.3% carbon by weight. In other examples, the steel may be a medium-carbon steel, with a carbon content of the base cutting edge in the range of about 0.3% to about 0.6% carbon by weight. In yet other examples, the steel may be a high-carbon steel, with a carbon content of the base cutting edge in the range of about 0.6% to about 1.2% carbon by weight. The rough bolt may have any suitable hardness, such as in the range of about 40 Rockwell Hardness Scale C (HRC) to about 65 HRC. In some cases, the threads 306 may have a lower carbon content than the rest of the rough bolt. In some cases, carbon may be removed, such as in the presence of hydrogen, from the threads 306. In other cases, the carbon content may be substantially uniform throughout the entirety of the rough bolt.

At block 904, a head cavity, defined by head sidewalls, may be formed on the head of the rough bolt. The head cavity may be formed by removing steel from a center of a head of the rough bolt, where the head had a flat top profile. The cavity 408 formation may be performed using any suitable machining process, such as sawing, grinding, shearing, punching, cutting, lathing, drilling, turning, milling, etc. As discussed herein, these machining processes may be performed using any suitable machine, such as a saw, a lathe, punching systems, drills, shearing systems, laser cutting systems, water cutting systems, etc. In alternate cases, the rough bolt may be formed with the head cavity 408 already formed. For example, the rough bolt may be forged and/or cast in a manner that forms the head cavity 408 within the head 308 of the rough bolt.

At block 906, the hard insert may be formed. The insert 314 may be fabricated from any suitable materials, such as hard materials like WC, Co-based materials, borides, oxides, nitrides, or carbides of refractory metals (e.g., Ti, Ta, W, Cr, Mo, etc.), alumina, corundum, SiC, or the like. The insert 314 may be fabricated using a sintering process, such as powder sintering, liquid sintering, or the like. In some cases, the sintering process may be enhanced with electric and/or magnetic fields. In general, powders of the constituent materials may be placed in a sintering mold and then heated and/or pressurized to form the insert 314. For example, WC particles may be placed in a sintering mold under compression and heat to form the insert 314. In some cases, the sintering process to form the insert 314 may use approximately 4% to 25% Co particles with the remainder WC particles to provide the insert 314 with Co in the range of about 5% to about 25%. In some cases, the sintering process to form the insert 314 may use approximately 6% to 15% Co particles with the remainder WC particles to provide the insert 314 with Co in the range of about 6% to about 15%. In other cases, the sintering process to form the insert 314 may use approximately 10% to 12% Co particles with the remainder WC particles to provide the insert 314 with Co in the range of about 10% to about 12%. In alternate cases, the insert 314 may be fabricated by mechanisms other than sintering.

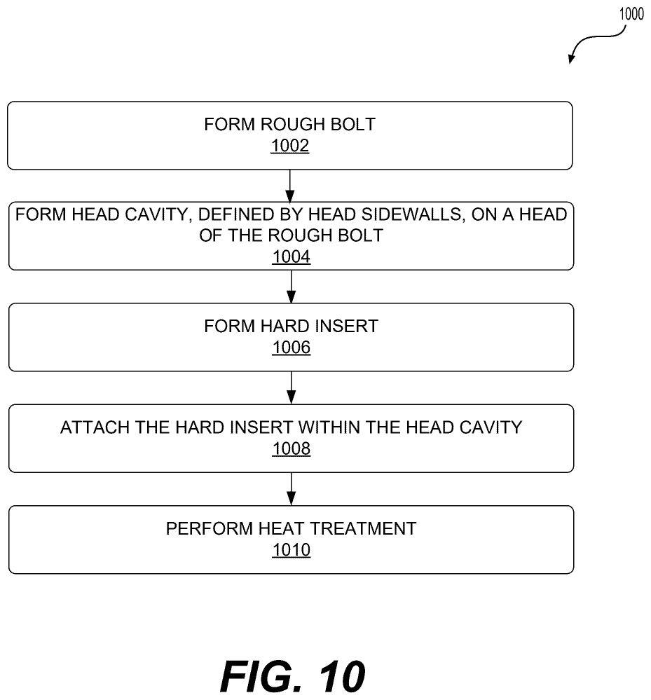

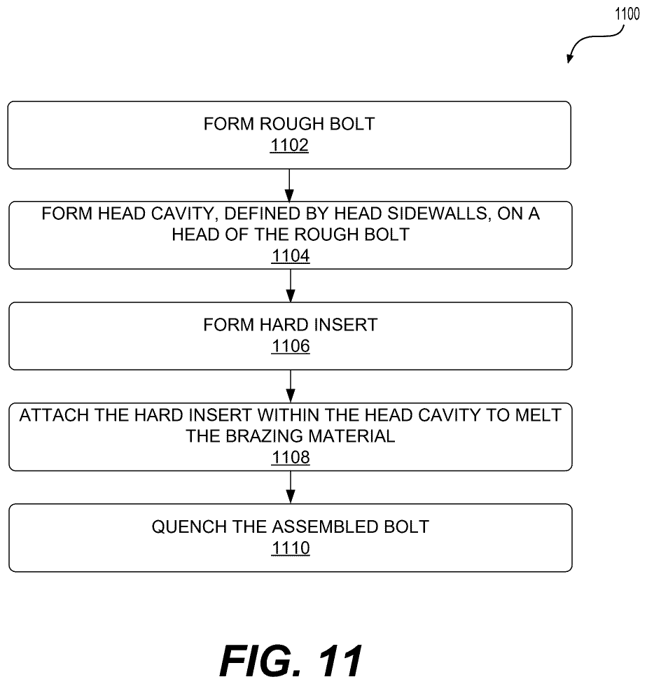

At block 908, the hard insert may be attached within the head cavity. The insert 314 may be attached to the head cavity 408 by any suitable joining mechanism, such as brazing, welding, soldering, fritting, etc. For example, in some cases, a Cu and/or Ni metallurgy may be used to braze the insert 314 in place within the head cavity 408. In other cases, other metals may be used for brazing the insert 314 in place, such as Ag, Zn, Sn, Co, Au, or the like. When the insert 314 is attached within the head cavity 408 of the head 308 of the rough bolt, the bolt 300 is formed and ready to use to hold the cutting edge 118 to the tool 114. In some cases, the brazing process conditions may be selected to not impart significant thermal energy to the rough bolt, so as to not change the crystal structure of the rough bolt. In other cases, the brazing process may modify the crystal structure of the rough bolt, which is further discussed in conjunction with FIGS. 10 and 11.

It should be noted that some of the operations of method 900 may be performed out of the order presented, with additional elements, and/or without some elements. Some of the operations of method 900 may further take place substantially concurrently and, therefore, may conclude in an order different from the order of operations shown above. For example, in some cases, where the head cavity 408 is formed while the rough bolt is formed, the processes of blocks 902 and 904 may be merged. Additionally, it will be understood that the threads 306 may be cut into the shank 302 of the bolt at the formation of the rough bolt (block 902) or subsequently. In some cases, the threads 306 may be cut after attaching the hard insert (block 908).

FIG. 10 is a flow diagram of a method to fabricate a bolt, according to examples of the disclosure. The processes of method 1000 may be performed by a single entity at a single location or any number of different entities at any variety of locations. The descriptions of blocks 1002, 1004, 1006, and 1008 may be substantially similar to the descriptions of blocks 902, 904, 906, and 908, respectively, of method 900 of FIG. 9, and in the interest of brevity will not be repeated here.

At block 1010, a heat treatment may be performed. The heat treatment may include heating the rough bolt with the insert 314 attached thereto. The heating may be performed in any suitable way, such as in a furnace, induction heating, or the like. The heating may be to any suitable temperature. For example, the rough bolt with the insert 314 may be heated to a temperature in a range of about 800° C. to about 1300° C. After the heating, the rough bolt with the insert 314 may be quenched to preferentially form martensitic and/or austenitic crystal structure. The quenching process may be any suitable quenching process, such as in air, water, oil, combinations thereof, or the like.

The heat treatment (e.g., heating above the eutectic point and quenching) may be performed after the brazing process to restore the hardness in the steel portions (e.g., the shank 302 and head 308) of the bolt 300. The hardness of the steel portions of the bolt 300 may diminish during the brazing process due to the thermal processes involved. The rough bolt with the insert 314 may be heated during the brazing process and the subsequent cool down may be at a rate that causes a crystallographic transformation from martensitic grain to ferrite and/or cementite grain structure. Thus, a subsequent heating and rapid cooling (e.g., quenching) process can restore the preferential martensitic grain structure that gives the steel portions relatively greater hardness. In some cases, the threads 306 may be cut into the shank 302 of the bolt 300 after the brazing process, but before the thermal treatment and rehardening processes of block 1010.

It should be noted that some of the operations of method 1000 may be performed out of the order presented, with additional elements, and/or without some elements. Some of the operations of method 1000 may further take place substantially concurrently and, therefore, may conclude in an order different from the order of operations shown above.

FIG. 11 is a flow diagram of a method to fabricate a bolt with in-situ quench, according to examples of the disclosure. The processes of method 1000 may be performed by a single entity at a single location or any number of different entities at any variety of locations. The descriptions of blocks 1102, 1104, 1106, and 1108 may be substantially similar to the descriptions of blocks 902, 904, 906, and 908, respectively, of method 900 of FIG. 9, and in the interest of brevity will not be repeated here.

At block 1110, the assembled bolt may be quenched. This quench may be a direct quench, where the rough bolt with the insert 314 is quenched directly from the temperature of the brazing process. The heating for the brazing process may be performed in any suitable way, such as in a furnace, induction heating, or the like. The heating may be to any suitable temperature. For example, the brazing process may be performed at temperatures in a range of about 550° C. to about 1300° C. In some cases, the time and temperature of the brazing process may alter the grain structure of the rough bolt. For example, the heating and subsequent cooldown of the rough bolt may result in at least partial transformation of harder austenitic and/or martensitic grain structure to softer pearlite, ferrite, and/or cementite. Thus, this in-situ direct to quench process may be used after the brazing process, where the bolt 400 is quenched directly from the brazing temperature. The quenching process may be any suitable quenching process, such as in air, water, oil, combinations thereof, or the like. For example, the rough bolt with the insert 314 may be brazed at a temperature in a range of about 800° C. to about 1300° C. After the heating the rough bolt with the insert 314 for brazing, the combination may be quenched to preferentially form martensitic and/or austenitic crystal structure.

Without this direct to quench process, where the bolt 300, formed as the attachment of the hard insert 314 onto the head 308 of the bolt 300, is quenched substantially from the temperature of the brazing process, the steel portions of the bolt 300 may be too soft. By performing the quench directly from the temperature of the brazing process, without another reheating process, a thermal process can be avoided, saving time and money.

It should be noted that some of the operations of method 1100 may be performed out of the order presented, with additional elements, and/or without some elements. Some of the operations of method 1100 may further take place substantially concurrently and, therefore, may conclude in an order different from the order of operations shown above.

### INDUSTRIAL APPLICABILITY

The present disclosure describes systems, structures, and methods to improve wear tolerance and durability of components, such as bolts 208 to mount cutting edges 202 to tools 206 and/or other components of a machine 100. The bolt 208, as disclosed herein, may have a hard insert 216 embedded therein and/or disposed thereon. The fasteners and bolts 208, as disclosed herein, may be utilized in other applications where wear protection of a fastener is desired.

As a result of the systems, apparatus, and methods described herein, consumable parts of machines 100, such as bolts 208 may have a greater lifetime than they otherwise would. The bolt 208 may further provide some wear protection to other consumable components, such as the cutting edge 118 itself. For example, the bolts 208 and cutting edges 118 described herein may have greater service lifetime than for bolts that are formed without the hard insert. This reduces field downtime, reduces the frequency of servicing and maintenance, and overall reduces the cost of heavy equipment, such as machines 100. The improved reliability and reduced field-level downtime also improves the user experience, such that the machine 100 can be devoted to its intended purpose for longer times and for an overall greater percentage of its lifetime. Improved machine 100 uptime and reduced scheduled maintenance may allow for more efficient deployment of resources (e.g., fewer, but more reliable machines 100 at a construction site). Thus, the technologies disclosed herein improve the efficiency of project resources (e.g., construction resources, mining resources, etc.), provide greater uptime of project resources, and improves the financial performance (e.g., return on investment (ROI), return on capital (ROC), etc.) of project resources.

While aspects of the present disclosure have been particularly shown and described with reference to the examples above, it will be understood by those skilled in the art that various additional examples may be contemplated by the modification of the disclosed machines, systems and methods without departing from the spirit and scope of what is disclosed. Such examples should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

1. A bolt, comprising:
a shank having an end;
threading extending at least partially along an outer surface of the shank;
a head coupled to the shank opposing the end, the head having a surface; and
an insert disposed at least partially over the surface of the head, the insert having a first side and a second side opposing the first side, wherein:
the first side defines spacers that protrude from the first side and contact the surface of the head and provide an offset between the surface of the head and the insert,
the first side defines a topographical feature configured to indicate wear of the insert;
the insert includes tungsten carbide (WC) and cobalt (Co), and
the insert is harder than the head.

2. The bolt of claim 1, further comprising an intermediary region between the head and the shank of the bolt, the intermediary region including a countersink feature configured to mate with a cutting edge.

3. The bolt of claim 1, wherein the shank has a hardness in a range of about 48 HRC to about 60 HRC.

4. The bolt of claim 1, wherein the insert comprises a Co concentration in a range of about 6% to about 13% by weight.

5. The bolt of claim 4, wherein the insert comprises the Co concentration in a range of about 10% to about 12% by weight.

6. The bolt of claim 1, further comprising brazing between the head and the insert, the brazing comprising at least one of copper (Cu) or nickel (Ni).

7. The bolt of claim 1, wherein the insert includes a base portion, the base portion including the first side and disposed within a cavity within the head.

8. The bolt of claim 7, wherein the insert includes a lip that extends over a sidewall surrounding the cavity within the head.

9-15. (canceled)

16. A machine, comprising:
a tool;
a cutting edge; and
a bolt used to attach the cutting edge to the tool, the bolt further comprising:
a shank having an end;
threading extending at least partially along an outer surface of the shank;
a head coupled to the shank opposing the end, the head having a surface; and
an insert disposed at least partially over the surface of the head, wherein the insert has a hardness greater than the hardness of the head.

17. The machine of claim 16, wherein the insert includes tungsten carbide (WC) and cobalt (Co).

18. The machine of claim 17, wherein the insert includes the Co at a concentration in a range of about 6% to about 13% by weight.

19. The machine of claim 16, further comprising a sidewall defining a cavity within the head, wherein a base portion of the insert is disposed within the cavity and a lip of the insert overlies the sidewall.

20. The machine of claim 19, further comprising brazing material disposed between the base portion and the surface of the head within the cavity.

21. A bolt, comprising:
a shank having an end;
a head coupled to the shank opposing the end, the head having a surface; and
an insert disposed at least partially over the surface of the head, the insert having a first side and a second side opposing the first side, wherein:
the first side defines spacers that protrude from the first side and contact the surface of the head and provide an offset between the surface of the head and the insert,
the insert includes a lip that extends over a sidewall surrounding the cavity within the head, and
the insert includes tungsten carbide (WC) and cobalt (Co).

22. The bolt of claim 21, wherein the head comprises boron carbon steel.

23. The bolt of claim 21, wherein the head has a hardness in a range of 45 Rockwell Hardness Scale C (HRC) to 63 HRC.

24. The bolt of claim 21, wherein the insert has a hardness in a range of 80 Rockwell Hardness Scale A (HRA) to 95 HRA.

25. The bolt of claim 21, wherein the insert includes a base portion, the base portion including the first side and disposed within a cavity within the head.
